(19) United States
(12) Patent Application Publication
(10) Pub. No.: US 2019/0143285 A1
(43) Pub. Date: May 16, 2019

(54) AUTOMATIC INK COLOR BLENDING APPARATUS

(71) Applicant: Chunlong SANG, Nanjing (CN)

(72) Inventor: Chunlong SANG, Nanjing (CN)

(21) Appl. No.: 16/307,160

(22) PCT Filed: May 26, 2017
(86) PCT No.: PCT/CN2017/086037

§ 371 Date: Dec. 5, 2018

(30) Foreign Application Priority Data
Jun. 6, 2016 (CN) 201610398369.1

(51) Int. Cl. B01F 15/04; B01F 15/02; B41F 31/03

(52) U.S. Cl. CPC B01F 15/0408; B01F 15/0203; B01F 2215/0059; B01F 15/0425; B41F 31/03; B01F 15/0216

(57) ABSTRACT

Disclosed is an automatic ink color blending apparatus, which comprises an apparatus cabinet (1) with a carrying platform (11), an ink bucket moving platform (2) provided on the carrying platform, the ink bucket moving platform including a moving guide rail (21), a weighing device (22) and an ink bucket (23), and wherein the ink bucket is disposed on the weighing device,the weighing device is provided on the moving guide rail and moves along the moving guide rail, an ink supply tank (3) arranged above the ink bucket moving platform,and wherein the ink supply tank includes a plurality of ink supply devices (31), each of which provides inks of different chromaticity and a control terminal (4) provided on the carrying platform, which is electrically connected to the ink supply tank, the moving guide rail and the weighing device respectively, for obtaining target chromaticity information, and generating control information of ink selection to select one or several ink supply devices to inject the corresponding chromaticity ink into the ink bucket sucessively, wherein the control information of ink selection includes selection information of an ink device and information of the amount of ink to be injected.

This application claims priority of Chinese Patent Application No. 201610398369.1, entitled “Automatic ink color blending apparatus”, filed before China Patent Office on Jun. 6, 2016.

### TECHNICAL FIELD

The present invention relates to the technical field of printing device, and in particular to an automatic ink color blending apparatus.

### RELATED ART

At present, printing plants need to perform blending the spot color ink in spot color printing. Most of this work is achieved by being shoveled manually into the weighing barrel for blending. However, there are some defects, such as having complicated process, difficultly controlling quantity of ink blending, resulting in waste, frequently changing different base color accessories during the procedure of color test, complicated operating, and semi-solidification of ink caused by low temperature, being unable to stir quickly and waste of production time.

To this end, the prior art provides an ink color mixing equipment for conveying the color ink to an iron ink bucket by using a high-power plunger pump or a screw pump, which may solve the problem of manual operation.

However, it still uses traditional iron ink bucket and requires high-power and high-pressure liquid pumps with high price. When more than 12 base color is needed to be blended, the cost of such ink-mixing machine should reach several million RMB, thereby the market is difficult to open. In addition, for pumping ink of the iron ink bucket, it is often difficult to completely empty the residue in the ink bucket, resulting in waste. Moreover, the capacity of the package of ink iron bucket on the market is mostly 1000 grams and 2000 grams so that when an order is received, the iron ink bucket is needed to be changed repeatedly, resulting in that the work is cumbersome and time consuming.

### SUMMARY

The purpose of the present invention is to provide an automatic ink color blending apparatus, which may achieve the advantages that ink color chromaticity is automatically blended, in order to avoid cumbersome manual operation, an ink package of flexible packaging in combination with an automatic extrusion device is utilized by the inventive method so that ink residue is minimized and a large number of inks is saved, the color test process is fast and convenient, a lot of time during color debugging is saved, and the ambient temperature is automatically sensed to keep the local environment of the ink package warm, thereby it is ensured that it affects a good ink extrusion under different environmental conditions to facilitate rapid stirring of the extruded ink. And By using the inventive apparatus, the cost for manufacturing and utilizing is pretty low, and it may greatly reduce the labor and material cost by automatically blending the ink chromaticity.

To achieve the above object, the present invention provides an automatic ink color blending apparatus, which comprises:

an apparatus cabinet (1) having a carrying platform (11),

an ink bucket moving platform (2) provided on the carrying platform (11) wherein the ink bucket moving platform (2) includes a moving guide rail (21), a weighing device (22) and an ink bucket (23) with the ink bucket (23) being disposed on the weighing device (22), and the weighing device (22) being disposed on the moving guide rail (21) and moving along the moving guide rail (21),

an ink supply tank (3) arranged above the ink bucket moving platform (2), wherein the ink supply tank (3) includes a plurality of ink supply devices (31), each one of which provides inks of different chromaticity,

a control terminal (4) provided on the carrying platform (11), electrically connected with the ink supply tank (3), the moving guide rail (21) and the weighing device (22) respectively, wherein, the control terminal (4) obtains target chromaticity information, generates control information of ink selection according to the target chromaticity information, selects one or more ink supply devices (31) to inject the ink with corresponding chromaticity into the ink bucket (23) successively, and the weighing device (22) performs on-line weighing of the amount of the injected ink for each type of chromaticity so that the actual injection amount of the ink for each type of chromaticity is same as the amount desired to be injected, further the control information of ink selection includes selection information of an ink device and information of the amount of ink desired to be injected.

Preferably, the apparatus further comprises: a spectral colorimeter (5), which is provided on the carrying platform (11) and connected to the control terminal (4), for scanning a target sample paper to obtain target chromaticity information of the target sample paper.

Preferably, the moving guide rail (21) comprises a towline cable (211), a rail (212), a transmission component (213) and a moving- platform driving motor (214).

The bottom of the weighing device (22) is provided with a transmission part and a sliding part, and the transmission component (213) is arranged to passes through the transmission part, the sliding part is in contact with the rail (212), One end of the towline cable (211) is connected to the weighing device (22), and the other end is connected to the control terminal (4), and the moving-platform driving motor (214) is connected to the control terminal (4) by a cable.

The moving-platform driving motor (214) drives the transmission component (213) to move the transmission part on the transmission component (213) so that the weighing device (22) moves on the moving guide rail (21).

Preferably, the ink supply device (31) comprises:

a backplane (311), the bottom of which has an ink tube outlet,

a rolling device (312), disposed on the upper portion of the backplane (311), which includes a pressure roller driving motor (3121) and two pressure rollers (3122) arranged in parallel, the two pressure rollers (3122) having synchronous gears at one end on the same side, wherein one of the pressure rollers (3122) is driven by the pressure roller driving motor (3121), and drives the other one to synchronous rotate in opposite directions through the synchronous gear,

a flexible packaging ink bag (313) pressed between the two pressure rollers (3122), with a bottom of which being upward, and a bag mouth of which being suspended downward, and the height of which in the backplane (311) being changed as the pressure rollers (3122) rotate,

a slide rail (314), installed in the backplane (311) along the suspending direction of the flexible package ink bag (313),

an ink pump (315) including an ink inlet joint which is inserted into the bag mouth, and an ink outlet,

a bag mouth fixing device (316), disposed on the slide rail (314), wherein the bag mouth and the ink inlet joint inserted into the bag mouth are fastened in the bag mouth fixing device 316), and the bag mouth fixing device (316) slides on the slide rail (314) as the height of the flexible package ink bag (313) is changed,

an ink outlet tube (317), with one end having a tube end connection structure connected to the ink outlet, and the other end passing through the ink tube outlet to be connected to an ink supply nozzle (318),

the ink supply nozzle (318), located below the ink tube outlet, and provided with a flow fine-tuning control valve (321),

a pump motor (319), connected to the ink pump (315) which drives the ink pump (315) to pump the ink from the flexible package ink bag (313) which flows out from the ink supply nozzle (318) by passing through the ink outlet tube (317) and is injected into the ink bucket below.

Further preferably, the ink supply device (31)further comprises an ink bag detecting device (320,

the ink bag detecting device (320) being provided under the pressure rollers (3122);

when detecting the flexible packaging ink bag (313) being inserted under the two pressure rollers (3122), the ink bag detecting device (320) generating a first induction signal and sending it to the pressure roller driving motor (3121) for driving the two pressure rollers (3122) to respectively rotate by the preset angle in opposite directions so as to sandwich the bottom end of the flexible package ink bag (313) between the two pressure rollers (3122).

Preferably, the ink supply tank (3) further comprises a group of ink supply device bracket (32, on one of which each of the ink supply devices (31) is provided.

Further preferably, the ink supply device (31) is slidably connected to the ink supply device bracket (32).

Further preferably, the outside of the ink supply device bracket (32) has an ink chromaticity indicator (321).

Preferably, the temperature sensor (33) and the heating sheet group (34) are also provided in the ink supply tank (3).

The temperature sensor (33) and the heating sheet group (34) are respectively connected to the control terminal (4).

The temperature sensor (33) detects the temperature in the ink supply tank (3) to generate temperature detection data, when a detected temperature value corresponding to the temperature detection data is lower than the preset threshold, the control terminal (4) generates a heating control signal based on the received temperature detection data and transmits it to the heating sheet group 34, and then the heating sheet group (34) heats the ink supply tank (3).

Further preferably, the ink pump (315) is any one of an electric gear pump, an electric diaphragm pump or an electric screw pump.

The automatic ink color blending apparatus according to the embodiments of the present invention can achieve the advantage that ink color chromaticity is automatically blended to avoid cumbersome manual operation, an ink package of flexible packaging in combination with an automatic extrusion device is adopted by the inventive apparatus so that ink residue is minimized and a large number of inks is saved, the color test process is fast and convenient, a lot of time during color debugging is saved, and the ambient temperature is automatically sensed to keep the local environment of the ink package warm, thereby it is ensured that it affects a good ink extrusion under different environmental conditions to facilitate rapid stirring of the extruded ink. By using the inventive apparatus, the cost for manufacturing and utilizing is very low, and it may greatly reduce the labor and material cost by automatically blending the ink chromaticity.

### BRIEF DESCRIPTION OF THE DRAWINGS

FIG. 1 is an overall schematic diagram of an automatic ink color blending apparatus according to the embodiment of the present invention.

FIG. 2 is a stereogram of a moving guide rail and a weighing device according to the embodiment of the present invention.

FIG. 3 is a structure schematic diagram of an ink supply device according to the embodiment of the present invention.

FIG. 4 is a second structure schematic diagram of an ink supply device according to the embodiment of the present invention.

FIG. 5 is a third structure schematic diagram of an ink supply device according to the embodiment of the present invention.

FIG. 6 is a structure schematic diagram of an ink supply device sliding out of the ink supply tank according to the embodiment of the present invention.

FIG. 7 is a location schematic diagrams of temperature sensors and heater chip group in the ink supply tank according to the embodiment of the present invention.

### DETAILED DESCRIPTION

The following further describes technical solutions of the embodiments of the present invention in detail with reference to the accompanying drawings and the embodiments.

The automatic ink color blending apparatus according to embodiments of the present invention can achieve the advantages that ink color chromaticity is automatically blended and is to match target chromaticity.

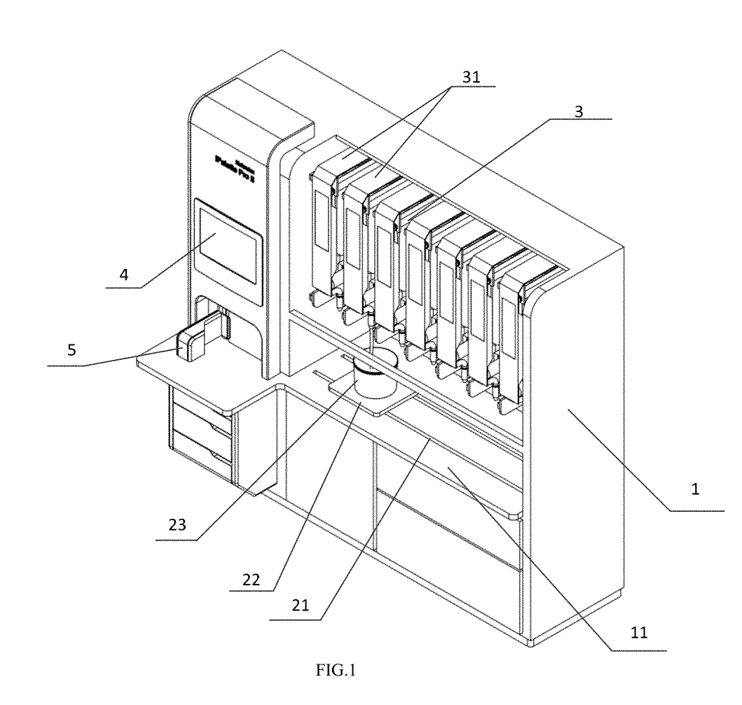

FIG. 1 is a structure schematic diagram of the outline of an automatic ink color blending apparatus. As shown in FIG. 1, the automatic ink color blending apparatus according to the embodiment comprises:

an apparatus cabinet 1 which has a carrying platform 11, and wherein a storage space can be provided on the lower part of the apparatus cabinet 1 for storing print sample papers, etc..

an ink bucket moving platform 2 provided on the carrying platform 11, and wherein the ink bucket moving platform 2 includes a moving guide rail 21, a weighing device 22 and an ink bucket 23, and the ink bucket 23 is arranged on the weighing device 22, as well as the weighing device 22 is arranged on the moving guide rail 21 and moves along the moving guide rail 21.

an ink supply tank 3 arranged above the ink bucket moving platform 2, and wherein the ink supply tank 3 includes a plurality of ink supply devices 31, and each of the ink supply devices 31 provides inks of different chromaticity. Additionally, the ink supply tank 3 has a cover plate (not shown in the figure), so that the plurality of ink supply devices 31 loaded in the ink supply tank 3 are in a relatively confined environment.

a control terminal 4 provided on the carrying platform 11, which is electrically connected with the ink supply tank 3, the moving guide rail 21 and the weighing device 22 respectively. and wherein the control terminal 4 obtains target chromaticity information, generates control information of ink selection for different primary inks according to the target chromaticity information in combination with the database preset scheme in the control terminal 4, selects one or several ink supply devices 31 to inject the ink with corresponding chromaticity into the ink bucket 23 successively, and the weighing device 22 performs on-line weighing of the amount of the injected ink while each ink supply device 31 is injected, so that the actual injection amount of the ink for each type of chromaticity is same as the amount desired to be injected. Specifically, the control information of ink selection may include selection information of an ink device for controlling selection of the corresponding ink supply device 31, and information of the amount of ink desired to be injected for determining the injection amount of the corresponding chromaticity ink for the selected ink supply device 31.

a spectral colorimeter 5 provided on the carrying platform 11 and connected to the control terminal 4, wherein the spectral colorimeter 5 scans a target sample paper to obtain the target chromaticity information thereof.

Alternatively, the manner for obtaining the target chromaticity information can be implemented by inputting a color number directly in the control terminal 4 by users. And the corresponding color scheme of the color number is prestored in the control terminal 4.

Below, the structure of each part and basic working principle are introduced first.

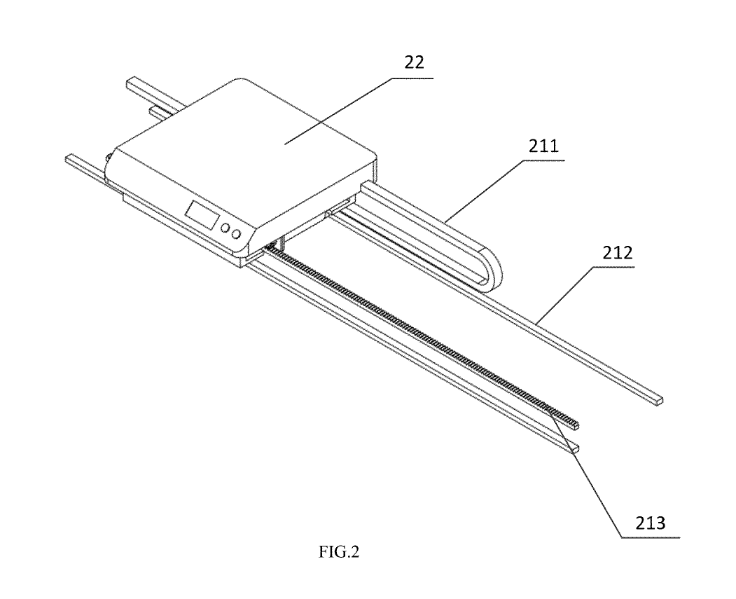

FIG. 2 is a stereogram of a moving guide rail and a weighing device according to an embodiment of the present invention. As shown in FIG. 2,

The moving guide rail 21 comprises a towline cable 211, a rail 212, a transmission component 213 and a moving- platform driving motor 214.

A transmission part and a sliding part are provided on the bottom of the weighing device 22.

The transmission component 213 is arranged to passes through the transmission part, the sliding part is in contact with the rail 212. One end of the towline cable 211 is connected to the weighing device 22, and the other end is connected to the control terminal 4, and the moving platform driving motor 214 is connected to the control terminal 4 by a cable.

The moving platform driving motor 214 drives the transmission component 213 to move the transmission part on the transmission component 213 so that the weighing device 22 moves on the moving guide rail 21.

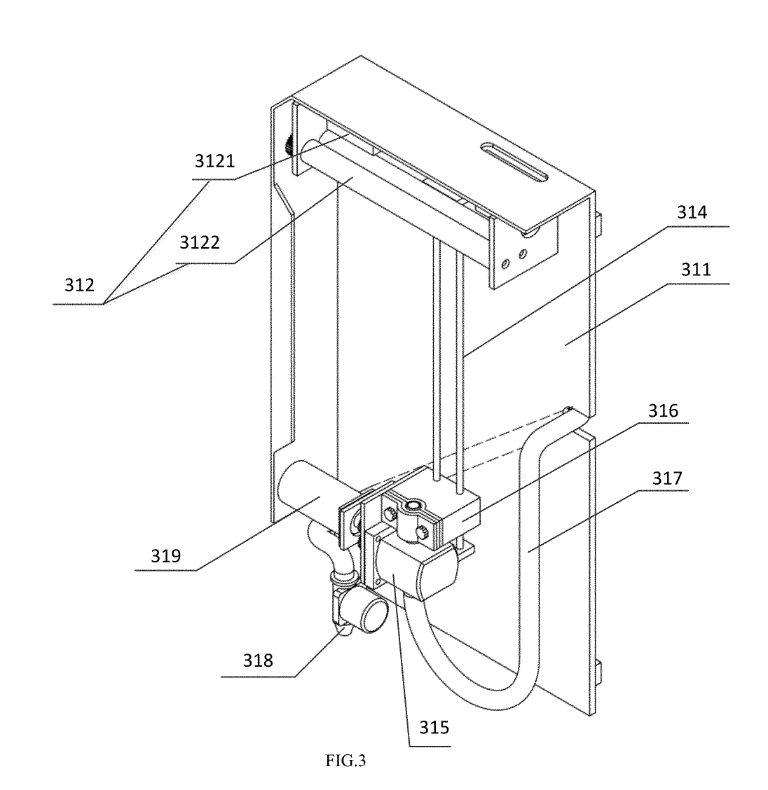

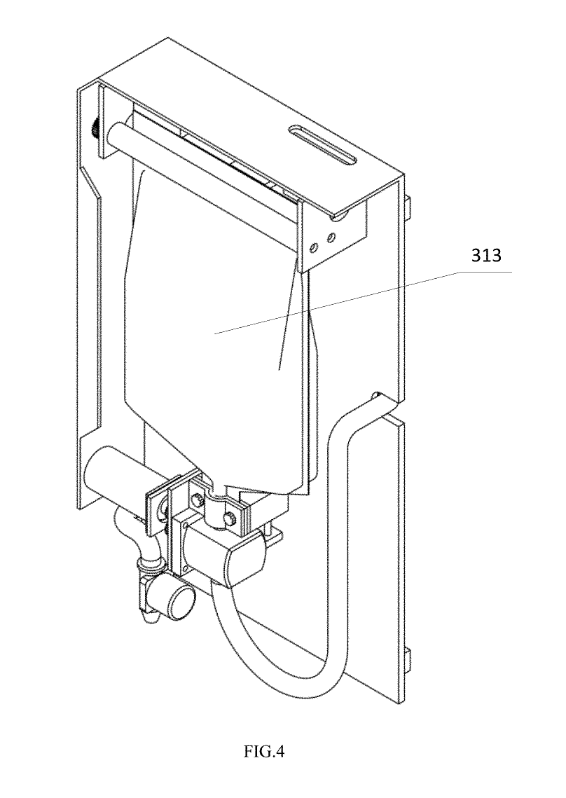

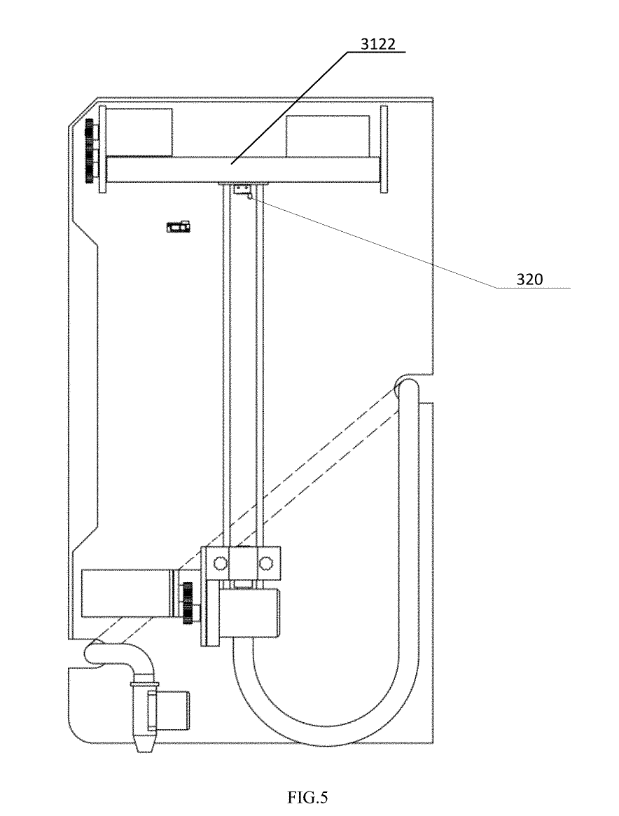

The schematic diagrams of the structure of ink supply devices according to embodiments of the present invention is shown in FIG. 3, FIG. 4, and FIG. 5. The detailed will be described combined with FIGS. 3, 4, and 5 as following.

The ink supply device 31 comprises a backplane 311, a rolling device 312, a flexible packaging ink bag 313, a slide rail 314, an ink pump 315, a bag mouth fixing device 316, an ink outlet tube 317, an ink supply nozzle 318 and a pump motor 319.

The bottom of the backplane 311 has an ink tube outlet.

The rolling device 312 is disposed on the upper portion of the backplane 311.The rolling device 312 comprises a pressure roller driving motor 3121 and two pressure rollers 3122 arranged in parallel. The two pressure rollers 3122 have synchronous gears at one end on the same side, wherein one of the pressure rollers 3122 is driven by the pressure roller driving motor 3121, and drives the other pressure roller 3122 to synchronous rotate in opposite directions through the synchronous gear.

The flexible packaging ink bag 313 is pressed between the two pressure rollers 3122, with the bottom of flexible packaging ink bag is upward, and the bag mouth of which is suspended downward, and the height of which in the backplane 311 is changed as the pressure rollers 3122 rotate.

The slide rail 314 is installed in the backplane 311 along the suspending direction of the flexible package ink bag 313.

The ink pump 315 comprises an ink inlet joint and an ink outlet. The ink inlet joint is inserted into the bag mouth. The ink pump 315 can adopt any one of an electric gear pump, an electric diaphragm pump or an electric screw pump.

The bag mouth fixing device 316 is disposed on the slide rail 314. The bag mouth and the ink inlet joint inserted into the bag mouth are fastened in the bag mouth fixing device 316. The bag mouth fixing device 316 slides on the slide rail 314 as the height of the flexible package ink bag 313 is changed;

One end of the ink outlet tube 317 has a tube end connection structure, which is connected to the ink outlet, and the other end passes through the ink tube outlet to be connected to an ink supply nozzle 318. The winding manner of the ink outlet tube 317 may preferably be the one shown in FIG. 3, that is, winding from the other side of the backplane 311 in order that it is ensured that the disposing of the ink outlet tube 317 does not affect the movement of the flexible package ink bag 313 and the bag mouth fixing device 316.

The ink supply nozzle 318 is located below the ink tube outlet and provided with a flow fine-tuning control valve 321.

The flow fine-tuning control valve 321 is connected to the control terminal 4 shown in FIG. 1, receives the flow fine-tuning control signal sent by the control terminal 4, and precisely controls the amount of ink output from the ink supply nozzle 318.

The pump motor 319 is connected to the ink pump 315, and drives the ink pump 315 to pump the ink from the flexible package ink bag 313. The ink flows out from the ink supply nozzle 318 by passing through the ink outlet tube 317, and is injected into the ink bucket below.

In a preferred embodiment, the ink supply device 31 further comprises an ink bag detecting device 320.

The ink bag detecting device 320 is provided under the pressure roller 3122. When detecting the flexible packaging ink bag 313 being inserted under the two pressure rollers 3122, the ink bag detecting device 320 generates a first induction signal and sends it to the pressure roller driving motor 3121for driving the two pressure rollers 3122 to respectively rotate by a preset angle in opposite directions, so that the bottom end of the flexible package ink bag 313 is sandwiched between the two pressure rollers 3122, thus the flexible package ink bag 313 is suspended in the ink supply device 31.

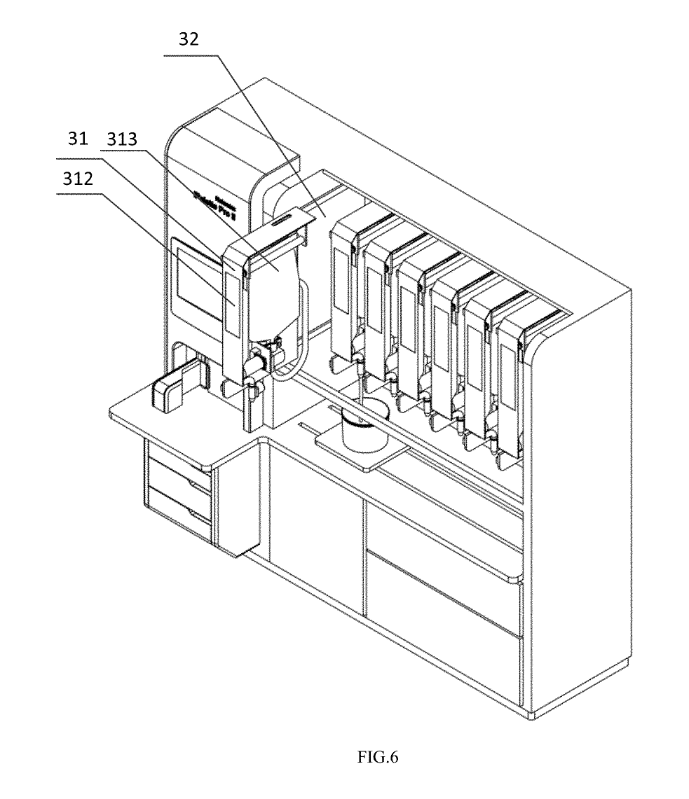

As shown in FIG. 6, the ink supply tank 3 further comprises a group of ink supply device bracket 32, each of the ink supply devices 31 is provided on one ink supply device bracket 32, and the ink supply device 31 is slidably connected to the ink supply device bracket 32. When apparatus maintenance, overhaul, or replacement of the flexible package ink bag 313 is required, the ink supply device 31 can be slid along the ink supply device bracket 32 to the position shown in FIG. 6 to facilitate the operation of the worker. The act of the ink supply device 31 sliding out or sliding in can be manually operated by a worker through a mechanical connection, or can be also automatically implemented by controlling the terminal operating device.

Further, the outside of the ink supply device bracket 32 has an ink chromaticity indicator 321 for identifying ink chromaticity information, such as color, color number and so on, of the ink in the ink supply device 31 carried by the ink supply device bracket 32. The ink chromaticity indicator 321 can be a conventional paper label or an electronic label. when it is an electronic label, a cable connection is provided between the ink supply device bracket 32 and the control terminal, and information of the ink chromaticity indicator of the ink loaded in the ink supply device 31 carried by the ink supply device bracket 32 is inputted by the control terminal.

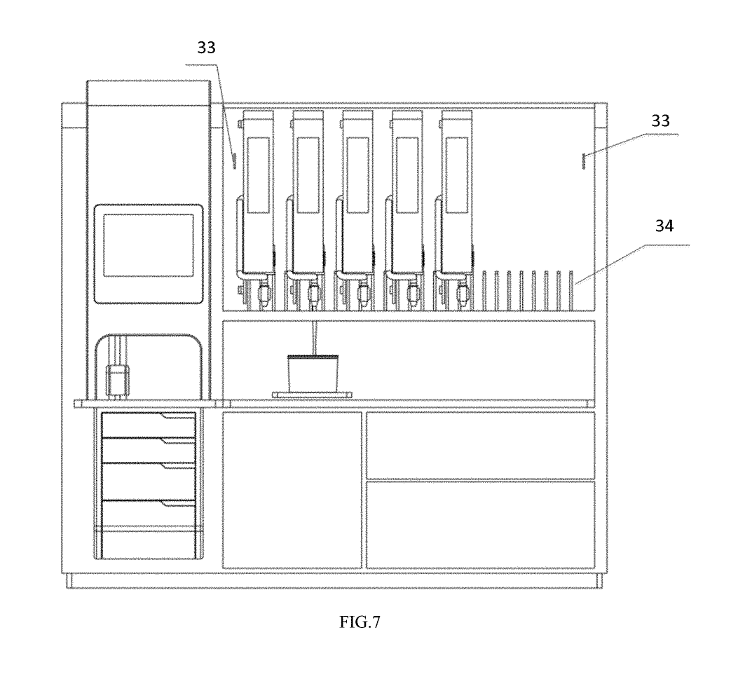

Further, as shown in FIG. 7 the temperature sensor 33 and the heating sheet group 34 are also arranged in the ink supply tank 3, so that it is ensured that the apparatus can be used in various temperature environments, and especially avoid semi-solid of the ink caused by low temperature in winter.

The temperature sensor 33 and the heating sheet group 34 are respectively connected to the control terminal 4.

The temperature sensor 33 detects the temperature in the ink supply tank 3 to generate temperature detection data. When the detected temperature value corresponding to the temperature detection data is lower than the preset threshold, the control terminal 4 generates a heating control signal based on the received temperature detection data and transmits it to the heating sheet group 34, and then the heating sheet group 34 heats the ink supply tank 3.

The above is an introduction to the components, the connection between the components, and the working principle of each component itself according to the embodiments of the automatic ink color blending apparatus. The following is a detailed description of the whole working process of the ink color blending apparatus combined with FIG. 1-7.

First of all, it should be noted that in the present embodiment, the flexible packaging ink bag 313 may be an ink flexible packaging bag having an anti-oxidation coating, a paper packaging layer and a waterproof packaging layer from the inside to the outside, for accommodating the oxidative polymerization type of ink. It may also be an ink flexible packaging bag having a three-layer structure of a hydrolyzable coating, a paper packaging layer and an anti-UV packaging layer from the inside to the outside, for accommodating the ultraviolet curable ink, or an ink bag in the form of a flexible packaging of other similar structures

It is illustrated by an example of a packaging bag having a waterproof packaging layer. The waterproof packaging layer needs to be removed firstly, and the ink supply device 31 is controlled to be sequentially slid out by the control terminal 4, and the packaging bag containing ink of different colors is added.

In operation, the ink flexible packaging bag with the paper packaging layer being exposed to the outermost layer is inserted between the two pressure rollers 3122 from below the two pressure rollers 3122. The ink bag detecting device 320 detects an object placed under the two pressure rollers 3122. When the object is detected, the ink bag detecting device 320 generates an induction signal to the pressure roller driving motor 3121. The pressure roller driving motor 3121 drives the two pressure rollers 3122 to rotate by a predetermined angle, for example, 540° or 720°, and the bottom end of the flexible packaging ink bag 313 is sandwiched between the two pressure rollers 3122. Due to the pressure between the two pressure rollers 3122, the sandwiched flexible packaging ink bag 313 does not fall out between the two pressure rollers 3122.

In specific applications, the ink bag detecting device 320 can use either photoelectric sensors or mechanical sensors.

After the flexible packaging ink bag 313 is sandwiched between the two press rolls 3122, it is necessary to manually connect the bag mouth, the ink pump 315, and the ink outlet tube 317, and fix the bag mouth by the bag mouth fixing device 316, so that the ink pump 315 and the pump motor 319 can move together as the flexible package ink bag 313 rises and falls.

After the flexible package ink bag 313 is installed, the ink supply device 31 is controlled to sequentially slide into the ink supply tank 3 by the control terminal 4.

After each or a desired number of ink supply devices 31 are loaded with the desired flexible package ink bag 313, the apparatus enters a standby state. At this time, the color information of the ink loaded in each ink supply device 31 is correspondingly stored in the control terminal 4.

In the standby state, the temperature sensor 33 detects the temperature in the ink supply tank 3 at continuous time or interval time according to the predetermined, and transmits the detection signal to the control terminal 4. When the temperature is found to be lower than the preset requirement, the control terminal 4 turns on the heating sheet group 34 to heat the ink supply tank 3.

When the temperature after heating is detected to meet the requirements, the apparatus enters the standby state and stops heating. At the same time, the temperature is continuously monitored.

Before working, the temperature sensor 33 will detect the temperature to ensure that the apparatus is working normally.

When in the working state, firstly, the target sample paper is scanned by the spectral colorimeter 5, the scan data is parsed by the control terminal 4 to obtain target chromaticity information of the target sample paper, or the target chromaticity information is obtained according to the color number input by the user from the control terminal 4.

The control terminal 4 automatically calculates the required color type and the weight of the ink desired to be injected according to the color information, the target chromaticity information, and the weight to be dispensed of the ink loaded in the ink supply device 31, and generates control information of ink selection, which includes selection information of an ink device and information of the amount of ink to be injected.

Here is a detailed example of the process of generating control information of ink selection.

The control terminal 4 obtains a sample file by scanning or user input. For example, a file in the format of PDF can be stored in the control terminal 4, and the control terminal 4 performs color separation on the color of the sample image in the sample file to obtain a plurality of layered separated single-color layer images that can be superimposed to form a sample image. The control terminal 4 calculates the total amount of ink used for each single color based on the area of each single color, the thickness of the cover required for ink printing, and the number of prints entered by the user in the control terminal 4.

The control terminal 4 can calculate color scheme for each single color required for printing according to a preset color scheme, and determine several ink supply devices 31 corresponding to the color information and the usage amount of the inks loaded in the several ink supply devices 31 according to the calculated color scheme.

The user only needs to select the color layer to be blended in the separated color layer, and then enters the quantity to be printed by using the control terminal 4, thereby realizing the selection of the ink device and the automatic calculation of the amount of ink required to be injected.

On this basis, according to the actual production schedule and estimated number of prints each shift, the automatic calculation of the amount of ink injected for each shift can be carried out to avoid excessive blended ink, dry and useless before being used for printing, and waste.

The control terminal 4 selects the corresponding ink supply device 31 according to the selection information of the ink device, and generates a control signal to control the ink bucket moving platform 2 to convey the ink bucket 23 below the corresponding ink supply device 31. The ink supply device 31 injects ink into the ink bucket 23, and the weighing device 22 constantly monitors the weight change of the ink bucket 23 carried thereon, thereby the actual injection amount is known, and the information of the actual injection amount is sent to the control terminal 4.

When the actual injection amount is close to the amount of ink desired to be injected to the corresponding ink supply device 31 calculated by the control terminal, the control terminal 4 generates a flow fine-tuning control signal to control the flow fine-tuning control valve 321 to open and close frequently, so that the ink output from the ink supply nozzle 318 is added to the ink bucket 23 in an intermittent dripping manner. Thereby, the amount of ink added to the ink bucket 23 can be accurately controlled, and when the actual injection amount weighed by the weighing device 22 reaches the amount of ink desired to be injected to the corresponding ink supply device 31, the control terminal 4 generates a control signal to stop the ink supply device 31 from continuing to inject the ink.

Subsequently, the next required ink supply device 31 is replaced according to the selection information of an ink device, until all of the required ink supply devices 31 complete the ink injection according to the selection information of an ink device and the amount of ink desired to be injected.

The ink added to the ink bucket 23 can be used for printing after being stirred. The automatic ink color blending apparatus according to the embodiments of the present invention can achieve the advantages that ink color chromaticity is automatically blended to avoid cumbersome manual operation, an ink package of flexible packaging in combination with an automatic extrusion device is adopted by the inventive apparatus so that the ink residue is minimized and a large number of inks is saved, the color test process is fast and convenient, a lot of time during color debugging is saved, and the ambient temperature is automatically sensed to keep the local environment of the ink package warm, thereby it is ensured that it affects a good ink extrusion under different environmental conditions to facilitate rapid stirring of the extruded ink. By using the inventive apparatus, the cost for manufacturing and utilizing is very low, and it may greatly reduce the labor and material cost by automatically blending the ink chromaticity.

A person skilled in the art should be further understood that the units and algorithm steps of each example described in connection with the embodiments disclosed herein can be implemented in electronic hardware, computer software or a combination of both, in order to clearly illustrate the alternative of hardware and software, the composition and steps of the examples have been generally described in terms of functions in the above description. Whether these functions are performed in hardware or software depends on the specific application and design constraints of technical solutions. A person skilled in the art can use different methods for implementing the described functions for each particular application, but such implementation should not be considered to be beyond the scope of the present invention.

The steps of the method or algorithm described in connection with the embodiments disclosed herein can be implemented in hardware, a software module executed by a processor, or a combination of both. The software module can be placed in random access memory (RAM), memory, read only memory (ROM), electrically programmable ROM, electrically erasable programmable ROM, registers, hard disk, removable disk, CD-ROM, or any other form of storage medium known in the art.

Above mentioned specific embodiments further describe aims, technical solutions and beneficial effects of the invention in detail, it should be understood that the above mentioned is merely specific embodiment of the present invention without limiting a protection scope of the present invention, and any modifications, equivalent substitutions, improvement, etc. made within the spirit and principle of the present invention should be included in the scope of the present invention.

1. An automatic ink color blending apparatus, characterized in that the automatic ink color blending apparatus comprises:
an apparatus cabinet (1) having a carrying platform (11),
an ink bucket moving platform (2) provided on the carrying platform (11) wherein the ink bucket moving platform (2) includes a moving guide rail (21), a weighing device (22) and an ink bucket (23)with the ink bucket (23) being disposed on the weighing device (22),and the weighing device (22) being disposed on the moving guide rail (21) and moving along the moving guide rail (21),
an ink supply tank (3) arranged above the ink bucket movement platform (2), wherein the ink supply tank (3) includes a plurality of ink supply devices (31), each one of which provides inks of different chromaticity,
a control terminal (4), provided on the carrying platform (11), electrically connected with the ink supply tank (3), the moving guide rail (21) and the weighing device (22) respectively wherein, the control terminal (4) obtains target chromaticity information, generates control information of ink selection according to the target chromaticity information, selects one or more ink supply devices (31) to inject the ink with corresponding chromaticity into the ink bucket (23) successively, and the weighing device (22) performs on-line weighing of the amount of the injected ink for each type of chromaticity so that the actual injection amount of the ink for each type of chromaticity is same as the amount desired to be injected, further the control information of ink selection includes selection information of an ink device and information of the amount of ink desired to be injected.

2. The automatic ink color blending apparatus according to claim 1, wherein the apparatus further comprises:
a spectral colorimeter (5) which is provided on the carrying platform (11) and connected to the control terminal (4), and scans a target sample paper to obtain target chromaticity information of the target sample paper.

3. The automatic ink color blending apparatus according to claim 1, wherein the moving guide rail (21) comprises a towline cable (211), a rail (212), a transmission component (213) and a moving- platform driving motor (214),
the bottom of the weighing device (22) is provided with a transmission part and a sliding part, and the transmission component (213) is arranged to passes through the transmission part, the sliding part is in contact with the rail (212), One end of the towline cable (211) is connected to the weighing device (22), and the other end is connected to the control terminal (4), and the moving- platform driving motor (214) is connected to the control terminal (4) by a cable,
the moving-platform driving motor (214) drives the transmission component (213) to move the transmission part on the transmission component (213) so that the weighing device (22) moves on the moving guide rail (21).

4. The automatic ink color blending apparatus according to claim 1, wherein the ink supply device (31) comprises:
a backplane (311), the bottom of which has an ink tube outlet,
a rolling device (312), disposed on the upper portion of the backplane (311), which includes a pressure roller driving motor (3121) and two pressure rollers (3122) arranged in parallel which have synchronous gears at one end on the same side, wherein one of the pressure rollers (3122) is driven by the pressure roller driving motor (3121), and drives the other one to synchronous rotate in opposite directions through the synchronous gear,
a flexible packaging ink bag (313) pressed between the two pressure rollers (3122), with a bottom of which being upward, and a bag mouth of which being suspended downward, and the height of which in the backplane (311) being changed as the pressure rollers (3122) rotate,
a slide rail (314), installed in the backplane (311) along the suspending direction of the flexible package ink bag (313),
an ink pump (315) including an ink inlet joint which is inserted into the bag mouth, and an ink outlet,
a bag mouth fixing device (316), disposed on the slide rail (314), wherein the bag mouth and the ink inlet joint inserted into the bag mouth are fastened in the bag mouth fixing device (316), and the bag mouth fixing device (316) slides on the slide rail (314) as the height of the flexible package ink bag (313) is changed,
an ink outlet tube (317), with one end having a tube end connection structure connected to the ink outlet, and the other end passing through the ink tube outlet to be connected to an ink supply nozzle (318),
the ink supply nozzle (318), located below the ink tube outlet and provided with a flow fine-tuning control valve (321),
a pump motor (319), connected to the ink pump (315) which drives the ink pump (315)to pump the ink from the flexible package ink bag (313)which flows out from the ink supply nozzle (318) by passing through the ink outlet tube (317) and is injected into the ink bucket below.

5. The automatic ink color blending apparatus according to claim 4, wherein the ink supply device (31) further comprises an ink bag detecting device (320),
the ink bag detecting device (320) being provided under the pressure roller (3122),
when detecting the flexible packaging ink bag (313) being inserted under the two pressure rollers (3122), the ink bag detecting device (320) generating a first induction signal and sending it to the pressure roller driving motor (3121) for driving the two pressure rollers (3122)to respectively rotate by the preset angle in opposite directions so as to sandwich the bottom end of the flexible package ink bag (313) between the two pressure rollers (3122).

6. The automatic ink color blending apparatus according to claim 1, wherein the ink supply tank (3) further comprises a group of ink supply device bracket (32), on one of which each of the ink supply devices (31)is provided.

7. The automatic ink color blending apparatus according to claim 6, wherein the ink supply device (31) is slidably connected to the ink supply device bracket 32.

8. The automatic ink color blending apparatus according to claim 6, wherein the outside of the ink supply device bracket (32) has an ink chromaticity indicator (321).

9. The automatic ink color blending apparatus according to claim 1, wherein a temperature sensor (33) and a heating sheet group (34) are provided in the ink supply tank (3),
the temperature sensor (33) and the heating sheet group (34) being respectively connected to the control terminal (4),
the temperature sensor (33)detecting the temperature in the ink supply tank (3) to generate temperature detection data, when a detected temperature value corresponding to the temperature detection data being lower than the preset threshold, the control terminal (4)generating a heating control signal based on the received temperature detection data and transmitting it to the heating sheet group (34), and then the heating sheet group (34) heating the ink supply tank (3).

10. The automatic ink color blending apparatus according to claim 4, wherein the ink pump (315) is any one of an electric gear pump, an electric diaphragm pump or an electric screw pump.
